(19) United States
(12) Patent Application Publication
(10) Pub. No.: US 2024/0157485 A1
(43) Pub. Date: May 16, 2024

(54) SOLDERING ALLOY, AND SOLDERING PASTE AND SOLDERING FOIL COMPRISING SUCH A SOLDERING ALLOY

(71) Applicant: MAPAL FABRIK FÜR PRÄZISIONSWERKZEUGE DR. KRESS KG, Aalen (DE)

(72) Inventors: Martin Kommer, Hüttlingen (DE); Wolfgang Baumann, Unterschneidheim-Zipplingen (DE)

(21) Appl. No.: 18/282,466

(22) PCT Filed: Mar. 15, 2022
(86) PCT No.: PCT/EP2022/056733

§ 371 Date: Sep. 15, 2023

(30) Foreign Application Priority Data
Mar. 18, 2021 (DE) 10 2021 202 673.7

(51) Int. Cl. B23K 35/30; B23K 35/02; C22C 5/08; C22C 30/02; C22C 30/06

(52) U.S. Cl. CPC B23K 35/3006; B23K 35/0233; B23K 35/025; C22C 5/08; C22C 30/02; C22C 30/06

(57) ABSTRACT

The invention relates to a solder alloy comprising
a mass fraction from at least 35% to at most 62% of silver,
a mass fraction from at least 10% to at most 30% of copper,
a mass fraction from at least 10% to at most 26% of zinc, wherein
the remaining mass fractions to 100%, except for unavoidable impurities, comprise at least one element selected from a group consisting of tin, gallium, manganese, nickel, and indium.

### CROSS REFERENCE TO RELATED APPLICATIONS

This application is a U.S. National Stage Application under 35 U.S.C. 371 of International Application No. PCT/EP2022/056733, filed Mar. 15, 2022, which claims priority to German Patent Application 10 2021 202 673.7, filed on Mar. 18, 2021. The contents of each of the which are hereby incorporated by reference in their entirety into the present disclosure.

### SUMMARY

The invention relates to a solder alloy, a solder paste with such a solder alloy and a solder foil with such a solder alloy.

In hard soldering, temperatures of over 650° C. are typically reached due to correspondingly high melting points of the solder alloys used. High temperatures are necessary in particular to ensure adequate shear strength of the resulting soldered joint. However, such high temperatures are unfavorable for certain materials. In particular, it is unfavorable for the tool sector that polycrystalline diamond (PCD) suffers or is damaged at such high temperatures.

The invention is therefore based on the task of creating a solder alloy, a solder paste with such a solder alloy and a solder foil with such a solder alloy, whereby the mentioned disadvantages are reduced, preferably do not occur.

The task is solved by providing the present technical teaching, in particular the teaching of the independent claims as well as the embodiments disclosed in the dependent claims and the description.

In particular, the task is solved by providing a solder alloy, wherein the solder alloy comprises:
a mass fraction from at least 35% to at most 62% of silver,
a mass fraction from at least 10% to at most 30% of copper,
is a mass fraction from at least 10% to at most 26% of zinc, and wherein
the remaining mass fractions to 100%, except for unavoidable impurities, comprise at least one element selected from a group consisting of tin, gallium, manganese, nickel, and indium.

Advantageously, the solder alloy has a comparatively low melting temperature, in particular in the range from 545° C. to at most 620° C., and can therefore be used at comparatively low soldering temperatures, in particular from 560° C. to at most 650° C. This means that even temperature-sensitive materials such as PCD can be soldered to the solder alloy without risk of damage. Nevertheless, high shear strengths are achieved, in particular of more than 1,500 Newton or more than 110 MPa, preferably of up to 315 MPa.

### DETAILED DECRIPTION

In a preferred embodiment, the mass fractions of silver mentioned in the context of the present technical teaching are determined by wet chemistry, in particular by precipitation titration, in particular in accordance with the ISO 11427:2014 standard in the version applicable on the date determining the priority of the present property right.

In a preferred embodiment, the mass fractions of the remaining elements in the context of the present technical teaching are determined by inductively coupled plasma optical emission spectrometry (ICP-OES), in particular in accordance with the standard SOP 2-EM-551 2018-03 in the version applicable on the date determining the priority of the present property right.

In particular, the solder alloy proposed herein is free of cadmium. Thus, in particular, the solder alloy is a Cd-free solder alloy.

In particular, the solder alloy proposed herein is a silver-based solder alloy. Thus, in particular, the solder alloy is an Ag-based solder alloy.

In particular, the solder alloy proposed herein is an Ag-based, Cd-free solder alloy.

In particular, the solder alloy proposed herein is versatile, especially for joining parts of various material compositions.

Preferably, the mass fraction of copper is from at least 11% to at most 26%.

According to a further development of the invention, it is provided that the mass fraction of silver is from at least 40% to at most 60%, preferably from at least 50% to at most 60%, and the mass fraction of copper is from at least 13% to at most 22%, preferably from at least 15% to at most 21%. In particular, in these ranges, the advantages already mentioned above are realized.

Preferably, the mass fraction of silver is from at least 42% to at most 58.5%, preferably from at least 54.5% to at most 58%, preferably to at most 57.5%, preferably to at most 57%.

According to a further development of the invention, it is provided that the solder alloy has a mass fraction of tin from at least 4% to at most 17%, preferably from at least 5% to at most 16%. Preferably, the mass fraction of tin is from at least 6% to at most 14%, preferably to at most 13.5%. In this case, the advantages already mentioned are realized in a particular way.

According to a further development of the invention, it is provided that the solder alloy has a mass fraction of gallium from at least 0.1% to at most 10%, preferably from at least 3% to at most 7%, preferably from at least 4% to at most 6%, preferably from at least 4.3% to at most 5.5%, preferably to at most 5%. In this case, the advantages already mentioned are realized in a particular manner.

According to a further development of the invention, it is provided that the solder alloy has a mass fraction from at least 0.1% to at most 16%, preferably from at least 2% to at most 15%, of indium. In the ranges mentioned here, the advantages already mentioned are realized in a particular way. Preferably, the mass fraction of indium is from at least 2.3% to at most 14%, preferably from at least 3% to at most 12%, preferably to at most 9%, preferably to at most 5%, preferably from at least 3.3% to at most 4.5%. Alternatively, the mass fraction of indium is preferably from at least 6% to at most 16%, preferably from at least 8% to at most 14%, preferably from at least 9% to at most 12%, preferably from at least 9.7% to at most 11%, preferably to at most 10.5%.

According to a further aspect of the invention, it is provided that the solder alloy has a mass fraction of from at least 4% to at most 17%, preferably from at least 5% to at most 16%, preferably from at least 7% to at most 15%, preferably from at least 8% to at most 14%, preferably from at least 9% to at most 13.7%, preferably from at least 9.5% to at most 13.5%, of tin, the mass fraction of tin preferably being from at least 10% to at most 13%, preferably from at least 10.5% to at most 12.7%, preferably from at least 11% to at most 12.5%, preferably from at least 11.5% to at most 12%, preferably 11.7%. In these ranges, the advantages already mentioned are realized in a particular way. In particular, the solder alloy proves to be very easy to roll, while at the same time having low brittleness and very high shear strength. Preferably, the mass fraction of silver is from at least 51% to at most 62%, preferably from at least 54% to at most 60%. Preferably, the mass fraction of copper is from at least 13.5% to at most 20%, preferably from at least 15% to at most 19%. Preferably, the mass fraction of zinc is from at least 9% to at most 19%, preferably from at least 11.5% to at most 15.5%. Preferably, the solder alloy is free of gallium. Alternatively or additionally, the solder alloy is preferably free of manganese. Alternatively or additionally, the solder alloy is preferably free of nickel. Alternatively or additionally, the solder alloy is preferably free of indium.

In the context of the present technical teachings, the phrase “free of” means in particular that the element designated in this way occurs at most in trace amounts, is preferably not detectable and/or is below the detection limit. Preferably, the summed mass fraction of the elements and impurities occurring in trace amounts is at most 0.15%, preferably at most 0.1%. Preferably, the summed mass fraction of the elements and impurities occurring in trace amounts is less than 0.15%, preferably less than 0.1%. Preferably, the mass fraction of a trace element or impurity is at most 0.04%, preferably at most 0.035%, preferably at most 0.01%, preferably at most 0.008%. Preferably, the mass fraction of a trace element or impurity is less than 0.01%, preferably less than 0.008%, preferably less than 0.005%, preferably less than 0.002%, more preferably less than 0.001%.

According to a further development of the invention, it is provided that the mass fraction of copper is from at least 13% to at most 19%, preferably from at least 14% to at most 18.7%, preferably from at least 17% to at most 18.5%, wherein the solder alloy has a mass fraction of tin of from at least 6% to at most 17%, preferably from at least 7% to at most 15%, preferably from at least 9% to at most 13%. Preferably, the mass fraction of silver is from at least 51% to at most 62%. Preferably, the mass fraction of zinc is from at least 9% to at most 20%. Preferably, the solder alloy is free of gallium. Alternatively or additionally, the solder alloy is preferably free of manganese. Alternatively or additionally, the solder alloy is preferably free of nickel. Alternatively or additionally, the solder alloy is preferably free of indium.

According to a further development of the invention, it is provided that the solder alloy has a mass fraction from at least 5% to at most 12%, preferably from at least 5.5% to at most 8%, preferably from at least 6% to at most 7%, preferably from at least 6.3% to at most 6.7% of tin, and a mass fraction from at least 2% to at most 9%, preferably from at least 2.5% to at most 6%, preferably from at least 3% to at most 5%, preferably from at least 3.5% to at most 4.5%, preferably from at least 3.7% to at most 4.3%, of indium. In these ranges, the previously mentioned advantages are realized in a particular way. In particular, the solder alloy proves to be easy to roll, while at the same time exhibiting very high shear strength. Preferably, the mass fraction of silver is from at least 52% to at most 62%. Preferably, the mass fraction of copper is from at least 13% to at most 23%. Preferably, the mass fraction of zinc is from at least 9% to at most 19%. Preferably, the solder alloy is free of gallium. Alternatively or additionally, the solder alloy is preferably free of manganese. Alternatively or additionally, the solder alloy is preferably free of nickel.

According to a further development of the invention, it is provided that the mass fraction of zinc is less than 19%, preferably less than 15%, wherein the alloy has a mass fraction of tin which is greater than 5%, preferably greater than 6%, and to at most 7%, wherein the alloy has a mass fraction of indium which is from at least 2.3% to at most 9%, preferably from at least 3% to at most 4.5%. In these ranges, the previously mentioned advantages are realized in a particular way. Preferably, the mass fraction of silver is from at least 52% to at most 62%. Preferably, the mass fraction of copper is from at least 13% to at most 23%. Preferably, the mass fraction of zinc is from at least 9% to at most 19%. Preferably, the solder alloy is free of gallium. Alternatively or additionally, the solder alloy is preferably free of manganese. Alternatively or additionally, the solder alloy is preferably free of nickel.

According to a further development of the invention, it is provided that the solder alloy has a mass fraction of indium from at least 6% to at most 16%, preferably from at least 9% to at most 11%, preferably from at least 9.7% to at most 10.7%, preferably from at least 10% to at most 10.5%. In these ranges, the previously mentioned advantages are realized in a particular way. In particular, this solder alloy exhibits a particularly high shear strength. Preferably, the mass fraction of silver is from at least 37% to at most 47%. Preferably, the mass fraction of copper is from at least 11% to at most 21%. Preferably, the mass fraction of zinc is from at least 18% to at most 28%. Preferably, the solder alloy is free of gallium.

According to a further development of the invention, it is provided that the solder alloy has a mass fraction of manganese from at least 0.1% to at most 10%, preferably from at least 2% to at most 6%, preferably from at least 3% to at most 5%, preferably from at least 3.5% to at most 4.5%, preferably from at least 3.7% to at most 4.3%. In these ranges, the previously mentioned advantages are realized in a particular way. Preferably, the mass fraction of silver is from at least 37% to at most 47%. Preferably, the mass fraction of copper is from at least 11% to at most 21%. Preferably, the mass fraction of zinc is from at least 18% to at most 28%. Preferably, the mass fraction of indium is from at least 6% to at most 16%. Preferably, the solder alloy is free of gallium.

According to a further development of the invention, it is provided that the solder alloy has a mass fraction of nickel of from at least 0.1% to at most 9% from at least 3% to at most 5%, preferably from at least 3.7% to at most 4.7%, preferably from at least 4.0% to at most 4.5%, preferably from at least 4.3% to at most 4.5%. In these ranges, the previously mentioned advantages are realized in a particular way. Preferably, the mass fraction of silver is from at least 37% to at most 47%. Preferably, the mass fraction of copper is from at least 11% to at most 21%. Preferably, the mass fraction of zinc is from at least 18% to at most 28%. Preferably, the mass fraction of indium is from at least 6% to at most 16%. Preferably, the mass fraction of manganese is from at least 0.1% to at most 10%. Preferably, the solder alloy is free of gallium.

According to a further development of the invention, it is provided that the solder alloy has a mass fraction of manganese that is greater than 3% and is at most 5%, wherein the solder alloy has a mass fraction of indium that is greater than 7% and is at most 13%, wherein the solder alloy has a mass fraction of nickel of from at least 3.5% to at most 5.5%. Preferably, the mass fraction of silver is from at least 37% to at most 47%. Preferably, the mass fraction of copper is from at least 11% to at most 21%. Preferably, the mass fraction of zinc is from at least 18% to at most 28%. Preferably, the solder alloy is free of gallium.

Specific preferred embodiments of solder alloys are described below:

[ALLOY 1-1]

In particular, a first embodiment of the solder alloy is preferred, in which the solder alloy has—in mass fractions—the following composition:
from at least 52% to at most 62% silver,
from at least 13% to at most 23% copper,
from at least 9% to at most 19% zinc,
from at least 7%, to at most 17% tin,
remaining mass fractions up to 100%: unavoidable impurities.

[ALLOY 1-2]

In particular, a second embodiment of the solder alloy is preferred, in which the solder alloy has—in mass fractions—the following composition:
from at least 54.7% to at most 58.7% silver,
from at least 15.7% to at most 19.7% copper,
from at least 11.5% to at most 15.5% zinc,
from at least 9.5%, to at most 13.5% tin,
remaining mass fractions up to 100%: unavoidable impurities.

[ALLOY 1-3]

In particular, a third embodiment of the solder alloy is preferred, in which the solder alloy has—in mass fractions—the following composition:
from at least 55.7% to at most 57.7% silver,
from at least 16.7% to at most 18.7% copper,
from at least 12.5% to at most 14.5% zinc,
from at least 10.5%, to at most 12.5% tin,
remaining mass fractions up to 100%: unavoidable impurities.

[ALLOY 1-4]

In particular, a fourth embodiment of the solder alloy is preferred, in which the solder alloy has—in mass fractions—the following composition:

5-56.7% silver,
17.7% copper,
13.5% zinc,
11.5% tin,
remaining mass fractions up to 100%: unavoidable impurities.

[ALLOY 2-1]

In particular, a fifth embodiment of the solder alloy is preferred, in which the solder alloy has—in mass fractions—the following composition:
from at least 51% to at most 61% silver,
from at least 13% to at most 23% copper,
from at least 10% to at most 20% zinc,
from at least 1% to at most 11% tin,
from at least 1% to at most 9% indium,
remaining mass fractions up to 100%: unavoidable impurities.

[ALLOY 2-2]

In particular, a sixth embodiment of the solder alloy is preferred, in which the solder alloy has—in mass fractions—the following composition:
from at least 54.3% to at most 58.3% silver,
from at least 16.3% to at most 20.3% copper, — from at least 12.5% to at most 16.5% zinc,
from at least 4.3% to at most 8.3% tin,
from at least 2% to at most 6% indium,
remaining mass fractions up to 100%: unavoidable impurities.

[ALLOY 2-3]

In particular, a seventh embodiment of the solder alloy is preferred, wherein the solder alloy has—in mass fractions—the following composition:
from at least 55.3% to at most 57.3% silver,
from at least 17.3% to at most 19.3% copper,
from at least 13.5% to at most 15.5% zinc,
from at least 5.3% to at most 7.3% tin,
from at least 3% to at most 5% indium,
remaining mass fractions up to 100%: unavoidable impurities.

[ALLOY 2-4]

In particular, an eighth embodiment of the solder alloy is preferred in which the solder alloy has—in mass fractions—the following composition:
56.3% silver,
18.2% copper,
14.6% zinc,
6.4% tin,
4.1% indium,
remaining mass fractions up to 100%: unavoidable impurities.

[ALLOY 3-1]

In particular, a ninth embodiment of the solder alloy is preferred, in which the solder alloy has—in mass fractions—the following composition:
from at least 38% to at most 48% silver,
from at least 12% to at most 21% copper,
from at least 18% to at most 28% zinc,
from at least 0.1% to at most 9% manganese,
from at least 0.1% to at most 9.3% nickel,
from at least 5% to at most 15% indium,
remaining mass fractions up to 100%: unavoidable impurities.

[ALLOY 3-2]

In particular, a tenth embodiment of the solder alloy is preferred, in which the solder alloy has—in mass fractions—the following composition:
from at least 40.7% to at most 44.7% silver,
from at least 13.5% to at most 17.5% copper,
from at least 20.7% to at most 24.7% zinc,
from at least 2% to at most 6% manganese,
from at least 2.3% to at most 6.3% nickel,
from at least 8.3% to at most 12.3% indium,
remaining mass fractions up to 100%: unavoidable impurities.

[ALLOY 3-3]

In particular, an eleventh embodiment of the solder alloy is preferred, in which the solder alloy has—in mass fractions—the following composition:
from at least 41.7% to at most 43.7% silver,
from at least 14.5% to at most 16.5% copper,
from at least 21.7% to at most 23.7% zinc,
from at least 3% to at most 5% manganese,
from at least 3.3% to at most 5.3% nickel,
from at least 9.3% to at most 11.3% indium,
remaining mass fractions up to 100%: unavoidable impurities.

[ALLOY 3-4]

In particular, a twelfth embodiment of the solder alloy is preferred, in which the solder alloy has—in mass fractions—the following composition:
42.8% silver,
15.5% copper,
22.8% zinc,
4.0% manganese,
4.4% nickel,
10.4% indium,
remaining mass fractions up to 100%: unavoidable impurities.

[Test Results]

Experimental results for specific preferred embodiments of solder alloys are described below:

[ALLOY T1]

In particular, a thirteenth embodiment solder alloy is preferred in which the solder alloy has—in mass fractions—the following composition:
57% silver,
18% copper,
14% zinc,
12% tin,
remaining mass fractions up to 100%: unavoidable impurities.

A melting range of 565° C. to 610° C. could be determined for this thirteenth embodiment solder alloy. A solder temperature range could be specified from 575° C. to 605° C. An average shear strength of 176 MPa was determined for a solded joint with the solder alloy.

[ALLOY T2]

In particular, a fourteenth embodiment of the solder alloy is preferred in which the solder alloy has—in mass fractions—the following composition:
56% silver,
18% copper,
15% zinc,
6% tin,
4% indium,
remaining mass fractions up to 100%: unavoidable impurities.

A melting range of 590° C. to 615° C. could be determined for this fourteenth embodiment solder alloy. A solding temperature range could be specified from 605° C. to 630° C. An average shear strength of 190 MPa was determined for a solded joint using the solder alloy.

[ALLOY T3]

In particular, a fifteenth embodiment of the solder alloy is preferred in which the solder alloy has—in mass fractions—the following composition:
43% silver,
16% copper,
23% zinc,
4% manganese,
4.5% nickel,
10.5% indium,
remaining mass fractions up to 100%: unavoidable impurities.

A melting range of 590° C. to 615° C. could be determined for this fifteenth embodiment solder alloy. A solding temperature range could be specified from 615° C. to 640° C. An average shear strength of 251 MPa was determined for a solder joint with the solder alloy.

The problem is also solved by providing a solder paste comprising a solder alloy according to the invention or a solder alloy according to one or more of the embodiments described above. In connection with the solder paste, in particular the advantages already described in connection with the solder alloy arise.

The solder paste preferably has, in addition to the solder alloy, a flux, in particular a hard soldering flux, or a binder. These additives do not influence the melting temperature of the solder alloy and thus, as a result, also of the solder paste, but rather evaporate during soldering. Suitable fluxes or binders are known in their own right, so they will not be discussed in detail here. Suitable fluxes are, however, for example: a flux according to DIN EN 1045:1997-08 in the version of Aug. 8, 1997, fluxes FH 10 to 12, in particular 181 PF Atmosin of Castolin GmbH in the composition available on the date determining the priority of the present property right, 1802 PF Atmosin of Castolin GmbH in the composition available on the date determining the priority of the present property right, or BrazeTec h 285 of SAXONIA Technical Materials GmbH in the composition available on the date determining the priority of the present property right.

Finally, the task is also solved by providing a solder foil comprising a solder alloy according to the invention or a solder alloy according to one or more of the embodiments described above. In connection with the solder foil, in particular the advantages already described in connection with the solder alloy arise.

In particular, the solder foil preferably comprises the solder alloy. In particular, the solder foil is preferably a thin rolled foil consisting of the solder alloy.

In a preferred embodiment, the solder foil has a thickness from at least 0.1 mm to at most 0.3 mm, preferably 0.2 mm. Alternatively or additionally, the solder foil preferably has a width from at least 0.5 cm to at most 15 cm, preferably from at least 1 cm to at most 10 cm, preferably from at least 2 cm to at most 8 cm, preferably from at least 4 cm to at most 6 cm, preferably 5 cm.

The invention is described in more detail below with reference to the drawing. Thereby show:

FIG. 1 a schematic representation of a dosage form of an embodiment example of a solder paste, and

FIG. 2 a schematic representation of a dosage form of an embodiment example of a solder foil.

### BRIEF DESCRIPTION OF THE DRAWINGS

FIG. 1 shows a schematic representation of a dosage form of an embodiment example of a solder paste 1. The solder paste 1 is arranged here in a tube 3 as an example. The solder paste 1 has a solder alloy according to the invention or a solder alloy according to one or more of the embodiments described above. The solder paste preferably has, in addition to the solder alloy, a flux, in particular hard soldering flux, or a binder.

FIG. 2 shows a schematic representation of a dosage form of an embodiment example of a solder foil 5. The solder foil 5 is preferably formed as a thin-rolled foil and is here exemplarily rolled up into a roll or coil 7. The solder foil 5 has a solder alloy according to the invention or a solder alloy according to one or more of the embodiments described above. In particular, the solder foil 5 comprises such a solder alloy. In a preferred embodiment, the solder foil 5 has a thickness D from at least 0.1 mm to at most 0.3 mm, preferably 0.2 mm. Alternatively or additionally, the solder foil preferably has a width B from at least 0.5 cm to at most 15 cm, preferably from at least 1 cm to at most 10 cm, preferably from at least 2 cm to at most 8 cm, preferably from at least 4 cm to at most 6 cm, preferably 5 cm.

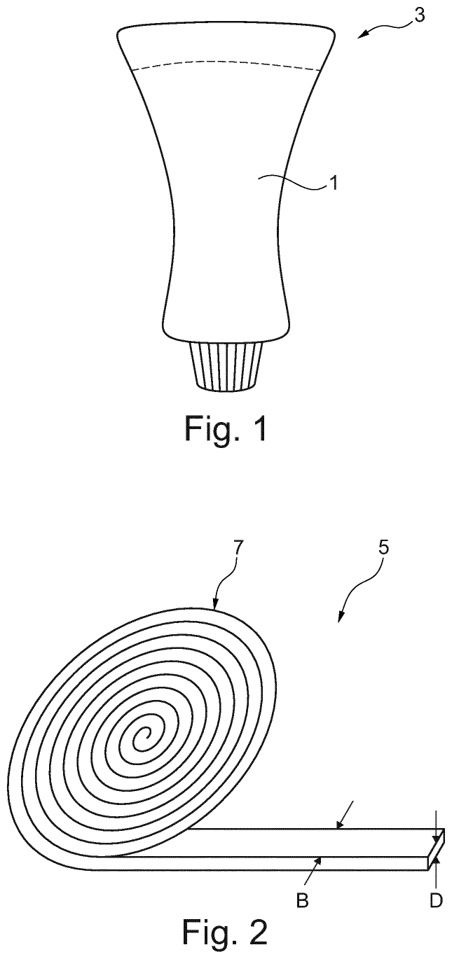

1. A solder alloy comprising
a mass fraction from at least 35% to at most 62% of silver,
a mass fraction from at least 10% to at most 30% of copper,
a mass fraction from at least 10% to at most 26% of zinc, wherein
the remaining mass fractions to 100%, except for unavoidable impurities, comprise at least one element selected from a group consisting of tin, gallium, manganese, nickel, and indium.

2. The solder alloy according to claim 1, wherein
the mass fraction of silver is from at least 40% to at most 60%, and
the mass fraction of copper is from at least 13% to at most 22%.

3. The solder alloy according to claim 1, having a mass fraction of tin of from at least 4% to at most 17%.

4. The solder alloy according to claim 1, having a mass fraction of from at least 0.1% to at most 16% of indium, preferably the mass fraction of indium being
from at least 2.3% to at most 14%, preferably from at least 3% to at most 12%, preferably from at least 3.3% to at most 4.5%, or
from at least 6% to at most 16%, preferably from at least 9% to at most 12%, more preferably from at least 9.7% to at most 10.5%.

5. The solder alloy according to claim 1, having a mass fraction of tin of from at least 4% to at most 17%, preferably from at least 9% to at most 13.7%, the mass fraction of tin preferably being from at least 10% to at most 13%, preferably from at least 11% to at most 12.5%, preferably from at least 11.5% to at most 12%, preferably 11.7%.

6. The solder alloy according to claim 1, wherein the mass fraction of copper is from at least 13% to at most 19%, preferably from at least 17% to at most 18.5%, and wherein the solder alloy has a mass fraction of tin of from at least 7% to at most 15%, preferably from at least 9% to at most 13%.

7. The solder alloy according to claim 1, having a mass fraction of tin from at least 5% to at most 12%, preferably from at least 5.5% to at most 8%, preferably from at least 6% to at most 7%, preferably from at least 6.3% to at most 6.7%, and a mass fraction of indium from at least 2% to at most 9%, preferably from at least 2.5% to at most 6%, preferably from at least 3% to at most 5%, preferably from at least 3.5% to at most 4.5%.

8. The solder alloy according to claim 1, wherein the mass fraction of zinc is less than 19%, preferably less than 15%, and with a mass fraction of tin that is greater than 5%, preferably greater than 6%, and to at most 12%, preferably to at most 7%, and with a mass fraction of indium from at least 2.3% to at most 9%, preferably from at least 3% to at most 4.5%.

9. The solder alloy according to claim 1, having a mass fraction of indium of from at least 6% to at most 16%, preferably from at least 9% to at most 11%, preferably from at least 9.7% to at most 10.7%, preferably from at least 10% to at most 10.5%.

10. The solder alloy according to claim 9, having a mass fraction of from at least 0.1% to at most 10%, preferably from at least 2% to at most 6%, preferably from at least 3% to at most 5%, preferably from at least 3.5% to at most 4.5%, of manganese.

11. The solder alloy according to claim 9, one of the claim 9 or 10, having a mass fraction of from at least 0.1% to at most 9%, preferably from at least 3% to at most 5%, preferably from at least 3.7% to at most 4.7%, preferably from at least 4.0% to at most 4.5%, preferably from at least 4.3% to at most 4.5%, of nickel.

12. The solder alloy according to claim 1, having a mass fraction of manganese which is greater than 3% and at most 5%, and having a mass fraction of indium which is greater than 7% and at most 13%, and having a mass fraction of nickel from at least 3.5% to at most 5.5%.

13. A solder paste, with a solder alloy according to claim 1.

14. A solder Solder foil, with a solder alloy according to claim 1.
